(19) United States
(12) Patent Application Publication
(10) Pub. No.: US 2015/0067195 A1
(43) Pub. Date: Mar. 5, 2015

(54) HDMI SOURCE AND SINK DEVICE OVER SINGLE HDMI CONNECTOR

(71) Applicants: Manish Sharma, Bangalore (IN); Ramakrishna Madhava, Bangalore (IN); Anantha Narayanan, Bangalore (IN); Arvind S, Bangalore (IN); Naveen G, Bangalore (IN)

(72) Inventors: Manish Sharma, Bangalore (IN); Ramakrishna Madhava, Bangalore (IN); Anantha Narayanan, Bangalore (IN); Arvind S, Bangalore (IN); Naveen G, Bangalore (IN)

(21) Appl. No.: 14/015,052

(22) Filed: Aug. 30, 2013

(51) Int. Cl. G06F 13/38

(52) U.S. Cl. CPC G06F 13/385
USPC 710/14

(57) ABSTRACT

Embodiments described herein provide an electronic device with a connector that includes a HDMI source and a HDMI sink. The electronic device also includes logic to determine whether a device coupled to the connector is a data source or a data sink, and if the device coupled to the connector is a data source, configure the connector to receive data.

### TECHNICAL FIELD

The present techniques relate generally to a high-definition multimedia interface (HDMI) connector. In particular, the present techniques relate to a HDMI source and sink on a single HDMI connector.

### BACKGROUND

Electronic devices are frequently connected to other electronic devices for a variety of reasons, including transferring data for display, among others. An example of a connection interface commonly used is high-definition multimedia interface (HDMI).

### BRIEF DESCRIPTION OF THE DRAWINGS

Certain exemplary examples are described in the following detailed description and in reference to the drawings, in which:

FIG. 1 is a block diagram of an example of a computing system;

FIG. 2 is a block diagram of an example of an electronic device;

FIG. 3 is a process flow diagram of an example of a method of configuring a HDMI connector;

FIG. 4 is a process flow diagram of another example of a method configuring a HDMI connector.

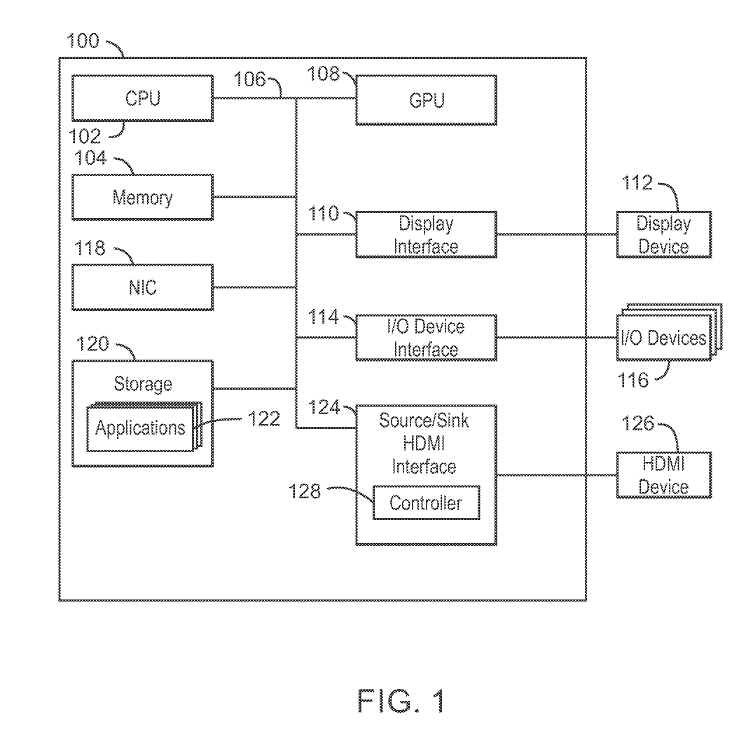

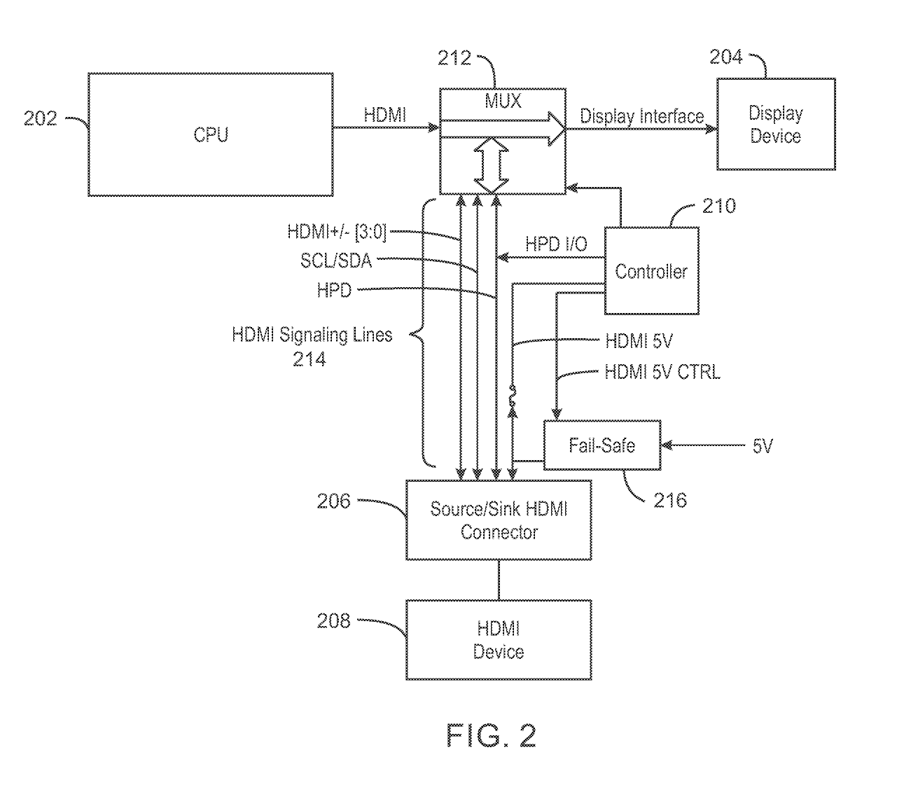

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION OF SPECIFIC EMBODIMENTS

Examples disclosed herein provide techniques for a HDMI source and a HDMI sink over single HDMI connector. HDMI is an interface commonly used to carry media content from source to sink. In a HDMI interface, data flows in one direction, from a first electronic device to a second electronic device. The electronic device that is transmitting the data is known as the source device (the output) and the electronic device that is receiving the data is known as the sink device (the input).

An electronic device can include a HDMI source and HDMI sink port. To receive data by the electronic device, a HDMI cable can be coupled to the HDMI sink port. To transfer data from the electronic device, the HDMI cable is coupled to the HDMI source port. If a cable is coupled to the HDMI source port, the electronic device will not receive data from an electronic device coupled to the other end of the cable. Therefore, a user is responsible for inserting the HDMI cable in the correct port of the electronic device for the activity the user intends. For example, if the user wishes to connect a cell phone to an electronic device in order to watch a movie playing on the cell phone on the electronic device display, the user is to connect the cell phone to the HDMI sink port of the electronic device display. If the user connects the cell phone to the HDMI source port of the electronic device, the movie will not play on the electronic device display.

Some electronic devices support both HDMI source and HDMI sink connectors. However, such electronic devices include two separate HDMI connectors. Each of the HDMI connectors is inserted in a port of the electronic device. As discussed above, if the HDMI connectors are coupled to the wrong port, the electronic device will not function in the manner intended by the user. Therefore, a user is still responsible for distinguishing the appropriate port in which to place each HDMI connector.

However, by creating a HDMI connector that supports both sink functionality and source functionality on the single connector, the user does not need to know which port to couple the HDMI connector to. Rather, the HDMI connector will be coupled to single port of the electronic device. The HDMI connector determines if a device connected to the HDMI connector is a source device or a sink device. Based on that determination, the HDMI connector configures itself to either receive data from the device or transfer data to the device.

FIG. 1 is a block diagram of an example of a computing system. The computing system can include an electronic device 100. The electronic device 100 may be virtually any type of electronic device including, for example and without limitation, a desktop computer, tablet computer, laptop computer, Ultrabook™, cellular phone, such as a smartphone, personal digital assistant (PDA), camera, video player or receiver, gaming console, and a large display such as a television, computer monitor, panel display, and the like. The electronic device 100 can include a central processing unit (CPU) 102 to execute stored instructions, as well as a memory device 104 that stores instructions that are executable by the CPU 102. The CPU 102 can be coupled to the memory device 104 by a bus 106. Additionally, the CPU 102 can be a single core processor, a multi-core processor, or any number of other configurations. Furthermore, the electronic device 100 can include more than one CPU 102.

The electronic device 100 can also include a graphics processing unit (GPU) 108. As shown, the CPU 102 can be coupled through the bus 106 to the GPU 108. The GPU 108 can perform any number of graphics operations within the electronic device 100. For example, the GPU 108 can render or manipulate graphics images, graphics frames, videos, or the like, to be displayed to a user of the electronic device 100. In some examples, the GPU 108 includes a number of graphics engines, wherein each graphics engine is configured to perform specific graphics tasks, or to execute specific types of workloads.

The memory device 104 can include random access memory (RAM), read only memory (ROM), flash memory, or any other suitable memory systems. For example, the memory device 104 can include dynamic random access memory (DRAM). The CPU 102 can be linked through the bus 106 to a display interface 110 to connect the electronic device 100 to a display device 112. The display device 112 can include a display screen that is a built-in component of the electronic device 100. The display device 112 can also include a computer monitor, television, or projector, among others, that is externally connected to the electronic device 100.

The CPU 102 can also be connected through the bus 106 to an input/output (I/O) device interface 114 to connect the electronic device 100 to one or more I/O devices 116. The I/O devices 116 can include, for example, a keyboard and a pointing device, wherein the pointing device can include a touchpad or a touchscreen, among others. The I/O devices 116 can be built-in components of the electronic device 100, or can be devices that are externally connected to the electronic device 100.

A network interface card (NIC) 118 can connect the electronic device 100 through the system bus 106 to a network (not depicted). The network 12 can be a wide area network (WAN), local area network (LAN), or the Internet, among others. In an example, the electronic device 100 can connect to a network via a wired connection or a wireless connection.

The electronic device 100 also includes a storage device 120. The storage device 120 is a physical memory such as a hard drive, solid state drive, an optical drive, a thumbdrive, a secure digital (SD) card, a microSD card, an array of drives, or any combinations thereof, among others. The storage device 120 can also include remote storage drives. The storage device 120 includes any number of applications 122 that run on the electronic device 100.

The electronic device 100 further includes a source/sink HDMI interface 124. The source/sink HDMI interface 124 configures a source/sink HDMI connector that supports both source functionality and sink functionality to transmit or receive data. A HDMI device 126 is coupled to the source/sink HDMI interface 124 and the HDMI device 126 can be a source device or a sink device. The source/sink HDMI interface 124 configures the source/sink HDMI connector based on detection of the electronic device 100 as a source device or a sink device. The source/sink HDMI interface 124 includes a controller 128. The controller 128 controls detection of the electronic device 100 as a source device or a sink device and routes the HDMI signals based on the detection.

It is to be understood the block diagram of FIG. 1 is not intended to indicate that the electronic device 100 is to include all of the components shown in FIG. 1 in every case. Further, any number of additional components can be included within the electronic device 100, depending on the details of the specific implementation.

FIG. 2 is a block diagram of an example of an electronic device. The electronic device 200 can be any suitable type of electronic device. For example, the electronic device 200 can be a desktop computer, a laptop computer, an all-in-one, a tablet computer, a cellular phone, or any other type of electronic device.

The electronic device 200 can include a CPU 202. The CPU can be any type of processor. In an example, the CPU 202 can include a converter (not shown), such as controller or a HDMI level shifter, to convert signals from the CPU 202 to HDMI compliant signals.

The electronic device 200 can also include a display device 204. In an example, the display device 204 can be integral to the electronic device 200. In another example, the display device 204 can be coupled to the electronic device 200, such as via a display interface.

The electronic device 200 can further include a source/sink HDMI connector 206. The source/sink HDMI connector 206 can support both HDMI source functionality and HDMI sink functionality on the single source/sink HDMI connector 206. The source/sink HDMI connector 206 is configured to transmit or receive data (i.e., as a HDMI source or a HDMI sink connector) based on determination of a HDMI device 208 coupled to the source/sink HDMI connector 206 as a source device or a sink device.

The electronic device can also include a controller 210. The controller 210 can be any suitable type of controller. For example, the controller 210 can be a discrete controller, a CPU based controller, a logic controller, a microcontroller, or a combination thereof. The controller 210 can detect and configure the electronic device 200 as a source device or a sink device based on detection result. In detecting whether the HDMI device 208 is a source device or a sink device, HDMI 5V power (VBUS) and hot plug detect (HPD) are both configured as input. Detection of the HDMI device 208 can be initialized in any suitable way, such as automatically or by receiving an initialization signal, such as a signal from a user. If the HDMI device 208 is a source device, the source device 208 will drive the VBUS (5V power) out. On valid detection of VBUS by electronic device, a hot plug detect (HPD) signal will be driven high and the MUX 212 will direct the data in sink mode to the electronic device display. If the HDMI device 208 is a sink device, the MUX will be reconfigured to source mode, i.e., to transfer data from the CPU 202 to the HDMI device 208. The 5V power VBUS is driven as defined by the HDMI specification and the HPD is polled for an interrupt. HDMI signaling lines 214 can transfer information between the HDMI connector 206 and the MUX 212. The HDMI signaling lines 214 can be standard HDMI signaling lines, direction being based on the source or sink functionality. For example, the HDMI signaling lines 214 can include four pairs of differential signaling and set of sideband signals SCL, SDA & HPD.

Upon detection of a source device or a sink device, the controller 210 instructs a multiplexer (MUX) 212 to direct data streams based on the detection. For example, the MUX 212 can initially be configured to direct data in sink mode. In sink mode, data transferred from a connected HDMI device 208 is transferred to the MUX 212, which directs the data stream to the display device 204. However, when the HDMI device 208 is determined to be a source device, the MUX 212 is reconfigured to direct data in source mode. Data to be transferred will be received from the CPU 202 in the MUX 212. The MUX 212 will direct the data stream to the HDMI connector 206 and through the HDMI connector 206 to the connected HDMI device 208. An audio stream can be routed based on detection of the HDMI device 208 as a source device or a sink device.

In an example, the controller 210 can initiate detection of the HDMI device 208 as a source or sink device in response to a signal from the user. The signal from the user can be any suitable type of signal. For example, the signal can be a button push or software interrupt.

In another example, the controller 210 can detect the HDMI device 208 as a source or sink device automatically, i.e., without any input from a user. During this automatic source/sink detection, controller 210 uses a mechanism similar to time domain switching to alternate the roles of source and sink. During source detection, the controller 210 behaves like a sink and waits for a valid response from a HDMI device. If nothing is detected within a time limit (tₐ or t_{b}), the arbiter switches to a sink detection phase and waits for a valid response. The time limit tₐ or t_{b} can be defined to be within a limit which does not result in an annoying user experience. For example, the time limit can be 10 to 100 milliseconds, which is not typically perceived as a long wait by a user. If nothing is detected within the time limit, the cycle of switching between source and sink repeats until either a source or a sink is detected or the HDMI cable is removed from the source/sink HDMI connector 206. In other words, the controller 210 configures the connector as a sink connector for a period of time and as a source connector for a period of time, alternating between the two configurations until a valid detection occurs.

In order to reduce system power consumption, the source/sink detection process can be started upon a valid detection of a cable insertion in the source/sink HDMI connector 206. A simple cable detection mechanism can be used to identify insertion of a HDMI cable in the HDMI connector 206. During automatic configuration, the source/sink HDMI connector 206 can be initially configured in sink mode where VBUS is input, HPD is output and driven low. When the HDMI connector 206 is in sink mode, the VBUS can be monitored. When an external source is connected to the HDMI connector 206, the 5V power is sampled high, by detecting this HPD is driven high. Upon detection of a valid external source, the controller 210 can stop alternating between source and sink mode and can remain in sink mode until the VBUS is detected low.

The electronic device 200 can also include a fail-safe 216 to protect the electronic device 200 and the HDMI device 208 from damage in the event of contentions between HDMI source and sink. The fail-safe 216 can be any suitable method of protecting the electronic device 200 for damage. For example, the fail-safe 216 can be a fuse and current limiting circuit. If the source and sink are not negotiated correctly within a specified period of time, such as between 100 msec-2 sec, 5V HDMI power and HPD are configured as input and are not driven. For example, if both the electronic device 200 and the HDMI device 208 try to drive the 5V power, the fail-safe 124 can be activated to return the 5V power to input and prevent the damage of the electronic device 200 and/or the HDMI device 208.

While the controller 210, the MUX 212, the HDMI signaling lines 214, and the fail-safe 216 are depicted here as components of the electronic device 200, it is to be understood that the listed components can be included in the source/sink HDMI connector 206. Additionally, it is to be understood the block diagram of FIG. 2 is not intended to indicate that the electronic device 200 is to include all of the components shown in FIG. 2 in every case. Further, any number of additional components can be included within the electronic device 200, depending on the details of the specific implementation.

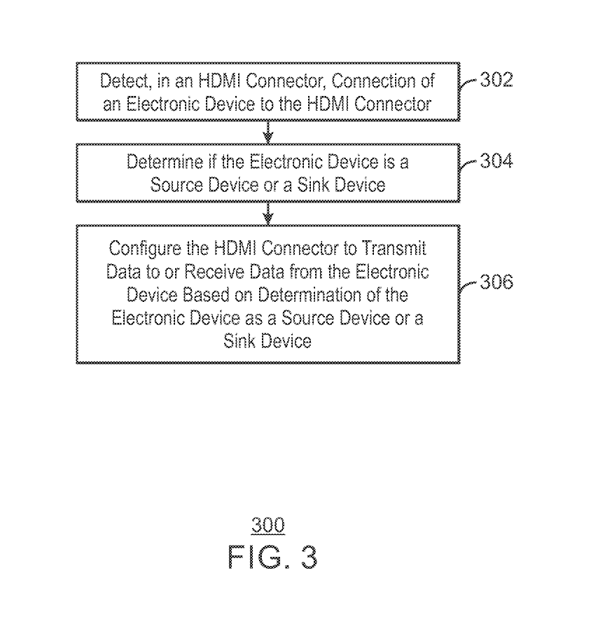

FIG. 3 is a process flow diagram of an example of a method of configuring a HDMI connector as source or sink based on user intervention like button press or software interrupt. The method can be implemented in an electronic device, such as electronic device 100. At block 302, connection of an electronic device to a HDMI connector can be detected in the HDMI connector. Any suitable method of detecting connection of the electronic device can be used.

At block 304, the HDMI connector can determine if the electronic device is a source device or a sink device. The HDMI 5V power and HPD can initially be configured as input. A controller can monitor the HDMI VBUS (5V power). If the VBUS is driven high, the electronic device is determined to be a source device. If the VBUS is not driven high, the electronic device is determined to be a sink device. Determination of the electronic device can be initiated in response to a signal, such as a signal from a user, or can be initiated automatically. For example, the determination can be initiated automatically by detection of the connection of the electronic device.

At block 306, the HDMI connector can be configured to transmit data or receive data from the electronic device based on determination of the electronic device as a source device or a sink device. The data can be any type of data. For example, the data can be media and/or audio. If the electronic device is determined to be a source device, the HDMI connector can be configured to receive data from the electronic device. If the electronic device is determined to be a sink device, the HDMI connector can be configured to transmit data to the electronic device.

It is to be understood the process flow diagram of FIG. 3 is not intended to indicate that the method 300 is to include all of the components shown in FIG. 3 in every case. Further, any number of additional components can be included within the method 300, depending on the details of the specific implementation.

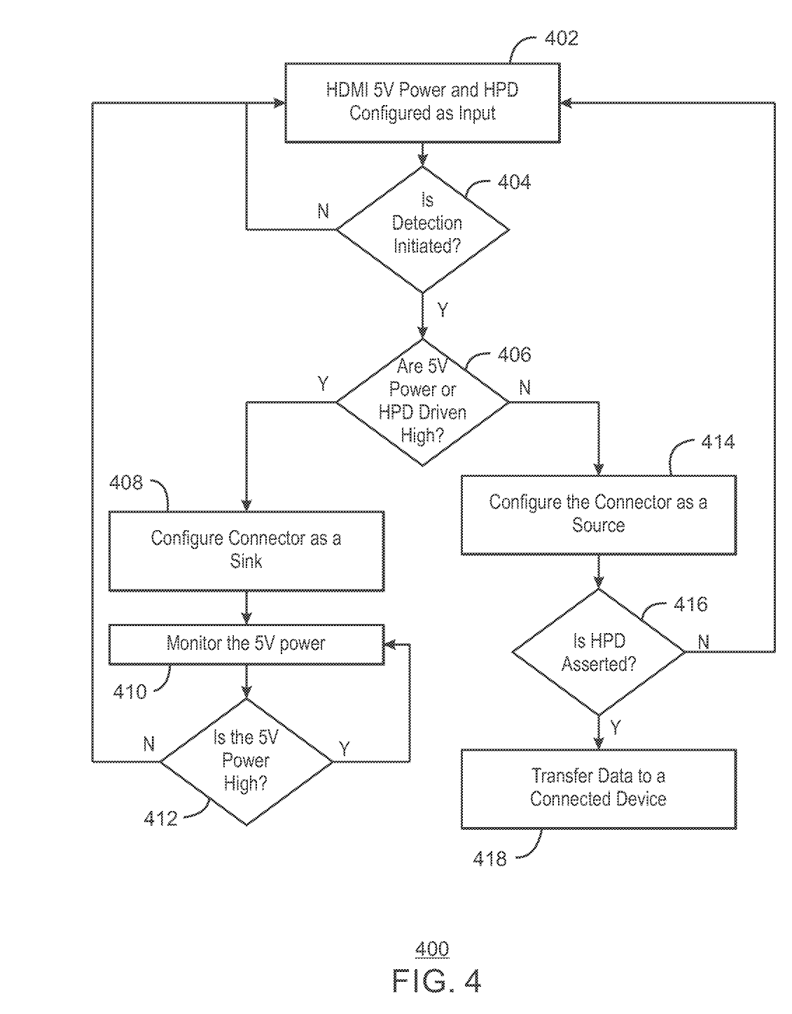

FIG. 4 is a process flow diagram of another example of a method of configuring a HDMI connector which does not require any user intervention. At block 402, HDMI VBUS and HPD can be configured as input. This configuration can be the initial configuration of the HDMI connector. At block 404, the HDMI connector can determine if detection of a device connected to the HDMI connector has been initiated. If detection has not been initiated, the method can return to block 402. If detection has been initiated, the connector can determine if the 5V power or HPD are driven high at block 406. If the 5V power or HPD have been driven high, the device can be determined to be a source and the connector can be configured as a sink at block 408. At block 410, the HDMI connector can monitor the VBUS. At block 412, the HDMI connector can determine if the VBUS is high. If the VBUS is high, the method can return to block 410. If the VBUS is not high, the method can return to block 402.

If the 5V power is not driven high, the device can be determined to be a sink device and the HDMI connector can be configured as a source at block 414. At block 416, the HDMI connector can determine if the HPD signal is asserted. If the HPD signal is asserted, at block 418 data can be transferred to the device. After transferring the data, the method can return to block 416. If the HPD signal is not asserted, the method can return to block 402.

It is to be understood the process flow diagram of FIG. 4 is not intended to indicate that the method 400 is to include all of the components shown in FIG. 4 in every case. Further, any number of additional components can be included within the method 400, depending on the details of the specific implementation.

### Example 1

An electronic device is provided. The electronic device includes a connector with an HDMI source and a HDMI sink. The electronic device also includes logic to determine whether a device coupled to the connector is a data source or a data sink, and if the device coupled to the connector is a data source, configure the connector to receive data. The electronic device also includes logic to configure the connector to transmit data if the device coupled to the connector is a data sink. The electronic device may also include a multiplexer that switches the connector between the HDMI source and the HDMI sink during configuration of the connector.

In some examples, an audio stream is routed through the connector based on whether the connector is configured to receive data or transmit data. The electronic device can also include fail-safe circuitry to provide protection against damage caused by source and sink contentions.

In some examples, the logic to determine whether the device coupled to the connector is a data source or a data sink is activated by a signal from a user. In some examples, the electronic device also includes logic to detect the coupling of the device to the connector and the logic to determine whether the device coupled to the connector is a data source or a data sink is activated automatically by the coupling.

### Example 2

An HDMI connector is provided. The HDMI connector includes a HDMI source to transmit media data and a HDMI sink to receive media data. The HDMI connector also includes circuitry to determine whether a device coupled to the HDMI connector is a data source or a data sink. If the device coupled to the HDMI connector is a data source, the circuitry configures the HDMI sink to receive data. If the device coupled to the HDMI connector is a data sink, the circuitry configures the HDMI source to transmit data. The HDMI connector may also include a multiplexer that switches the HDMI connector between the HDMI source and the HDMI sink during configuration of the HDMI connector.

In some embodiments, an audio stream is routed through the connector based on whether the device coupled to the HDMI connector is a data source or a data sink. The HDMI connector can also include fail-safe circuitry to provide protection against damage caused by source and sink contentions.

In some embodiments, the circuitry to determine whether the device coupled to the HDMI connector is a data source or a data sink is activated by a signal from a user. In some embodiments, the HDMI connector includes logic to detect the coupling of the device to the HDMI connector and the logic to determine whether the device coupled to the HDMI connector is a data source or a data sink is activated automatically by the coupling.

### Example 3

A method of operating an HDMI connector is provided. The method includes determining whether a device coupled to an HDMI connector is a data source or a data sink. The method also includes configuring the HDMI connector to receive data if the device coupled to the HDMI connector is a data source. The method also includes configuring the HDMI connector to transmit data if the device coupled to the HDMI connector is a data sink. Configuring the HDMI connector can include switching the HDMI connector to an HDMI sink or an HDMI source through a multiplexer.

The method may also include routing an audio stream based on whether the HDMI connector is configured to receive data or transmit data. The method may also include activating fail-safe circuitry if the device coupled to the HDMI connector is not identified as a data source or a data sink within a specified length of time.

The method may also include receiving an input from a user and determining whether the device coupled to the HDMI connector is a data source or a data sink in response to the input. The method may also include detecting the coupling of the device to the HDMI connector and determining whether the device coupled to the connector is a data source or a data sink in response to detecting the coupling.

In the foregoing description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

1. An electronic device, comprising:
a connector comprising a HDMI source and a HDMI sink; and
logic to determine whether a device coupled to the connector is a data source or a data sink, and if the device coupled to the connector is a data source, configure the connector to receive data;
wherein the logic to determine whether the device coupled to the connector is a data source or a data sink alternates between a source mode and a sink mode until sink detection or source detection occurs.

2. The electronic device of claim 1, the logic to configure the connector to transmit data if the device coupled to the connector is a data sink.

3. The electronic device of claim 1, wherein an audio stream is routed through the connector based on whether the connector is configured to receive data or transmit data.

4. The electronic device of claim 1, comprising fail-safe circuitry to provide protection against damage caused by source and sink contentions.

5. The electronic device of claim 1, wherein the logic to determine whether the device coupled to the connector is a data source or a data sink is activated by a signal from a user.

6. The electronic device of claim 1, comprising logic to detect the coupling of the device to the connector, wherein the logic to determine whether the device coupled to the connector is a data source or a data sink is activated automatically by the coupling.

7. The electronic device of claim 1, comprising a multiplexer that switches the connector between the HDMI source and the HDMI sink to configure the connector.

8. An HDMI connector, comprising
a HDMI source to transmit media data;
a HDMI sink to receive media data; and
circuitry to determine whether a device coupled to the HDMI connector is a data source or a data sink, and if the device coupled to the HDMI connector is a data source, configure the HDMI sink to receive data;
wherein the circuitry to determine whether the device coupled to the HDMI connector is a data source or a data sink alternates between a source mode and a sink mode until sink detection or source detection occurs.

9. The HDMI connector of claim 8, the circuitry to configure the HDMI source to transmit data if the device coupled to the HDMI connector is a data sink.

10. The HDMI connector of claim 8, wherein an audio stream is routed through the connector based on whether the device coupled to the HDMI connector is a data source or a data sink.

11. The HDMI connector of claim 8, comprising fail-safe circuitry to provide protection against damage caused by source and sink contentions.

12. The HDMI connector of claim 8, wherein the circuitry to determine whether the device coupled to the HDMI connector is a data source or a data sink is activated by a signal from a user.

13. The HDMI connector of claim 8, comprising logic to detect the coupling of the device to the HDMI connector, wherein the logic to determine whether the device coupled to the HDMI connector is a data source or a data sink is activated automatically by the coupling.

14. The HDMI connector of claim 8, comprising a multiplexer that switches the HDMI connector between the HDMI source and the HDMI sink to configure the HDMI connector.

15. A method, comprising:
determining whether a device coupled to an HDMI connector is a data source or a data sink by alternating between a source mode and a sink mode until sink detection or source detection occurs;
if the device coupled to the HDMI connector is a data source, configuring the HDMI connector to receive data; and
if the device coupled to the HDMI connector is a data sink, configuring the HDMI connector to transmit data.

16. The method of claim 15, comprising routing an audio stream based on whether the HDMI connector is configured to receive data or transmit data.

17. The method of claim 15, comprising activating fail-safe circuitry if the device coupled to the HDMI connector is not identified as a data source or a data sink within a specified length of time.

18. The method of claim 15, comprising receiving an input from a user and determining whether the device coupled to the HDMI connector is a data source or a data sink in response to the input.

19. The method of claim 15, comprising detecting the coupling of the device to the HDMI connector and determining whether the device coupled to the connector is a data source or a data sink in response to detecting the coupling.

20. The method of claim 15, wherein configuring the HDMI connector comprises switching the HDMI connector to an HDMI sink or an HDMI source through a multiplexer.
